(19) United States
(12) Patent Application Publication
(10) Pub. No.: US 2009/0032118 A1
(43) Pub. Date: Feb. 5, 2009

(54) CHECK VALVES WITH HINGE SHAFTS RETAINED BY BUSHINGS

(75) Inventors: RALPH L. DULAY, CHANDLER, AZ (US); MICHAEL KOLIC, PHOENIX, AZ (US); MAUREEN SUGAI, PHOENIX, AZ (US); DAVID B. TORNQUIST, CHANDLER, AZ (US); DON J. ATKINS, CHANDLER, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/831,371

(22) Filed: Jul. 31, 2007

(51) Int. Cl. F16K 15/00

(52) U.S. Cl. 137/527; 137/15.18

(57) ABSTRACT

Methods and apparatus are provided for retaining a hinge shaft of a check valve with a bushing. The check valve includes a valve body defining a flow passage therethrough; a hinge shaft; a bushing coupling the hinge shaft to the valve body; a pin secured to the valve body and engaging the bushing; and a closure element pivotally mounted on the hinge shaft for opening and closing the flow passage.

This invention was made with Government support under Contract Number N00019-02-C-3002 of the Joint Strike Fighter Program. The Government has certain rights in this invention

### TECHNICAL FIELD

The present invention generally relates to check valves with flapper closure elements, and more particularly relates to methods and apparatus for retaining the hinge shaft on which the closure elements of check valves are pivotally mounted.

### BACKGROUND

Check valves with flapper (or “wafer”) type closure elements are utilized in many industries. The check valves are typically mounted in pipes or other such conduits enable fluid flow in one direction and prevent fluid flow in the opposite direction. The closure elements of the check valve are pivotally mounted on a hinge shaft and can be biased closed by a resilient element such as a hinge spring. The hinge shaft is typically mounted by press fitting the ends of the hinge shaft in through holes formed in a valve body. The valve body is then mounted in a pipe or conduit, for example, to enable air intake for an engine of an aircraft.

Conventional check valves can encounter problems because the hinge shaft may loosen and migrate out of the valve body. This issue is exacerbated by the high temperature and vibration environments of many types of check valves, particularly where there is a clearance between the valve body and the walls of the conduit in which it is mounted.

Accordingly, it is desirable to provide methods and apparatus for satisfactory retaining hinge shafts in check valves. In addition, it is desirable to provide check valves that securely retain their hinge shafts in high temperature and vibration environments. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with one exemplary embodiment, a check valve includes a valve body defining a flow passage therethrough; a hinge shaft; a bushing coupling the hinge shaft to the valve body; a pin secured to the valve body and engaging the bushing; and a closure element pivotally mounted on the hinge shaft for opening and closing the flow passage.

In accordance with another exemplary embodiment, a method of retaining a hinge shaft in a check valve is provided. The method includes the steps of mounting a bushing on the hinge shaft to couple the hinge shaft to a valve body of the check valve; inserting a pin in a groove of the bushing; and securing the pin to a valve body of the check valve to prevent movement of the bushing and the hinge shaft in a longitudinal direction.

In accordance with yet another exemplary embodiment, a check valve includes a valve body comprising a flow passage and a bore; a hinge shaft; a bushing having a circumferential surface and coupling the hinge shaft to the valve body; a pin at least partially housed in the valve body and engaging the bushing at the circumferential surface to prevent movement of the bushing and the hinge shaft in a longitudinal direction; and a closure element pivotally mounted on the hinge shaft for opening and closing the flow passage.

### BRIEF DESCRIPTION OF THE DRAWINGS

The present invention will hereinafter be described in conjunction with the following drawing figures, wherein like numerals denote like elements, and wherein:

FIG. 1 is an isometric view of a check valve in accordance with an exemplary embodiment;

FIG. 2 is a cross-sectional view of the check valve of FIG. 1 through line 2-2;

FIG. 3 is a cross-sectional view of the check valve of FIG. 1 through line 3-3;

FIG. 4 is a more detailed view of a portion of FIG. 3; and

FIG. 5 is a more detailed view of another portion of FIG. 3.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

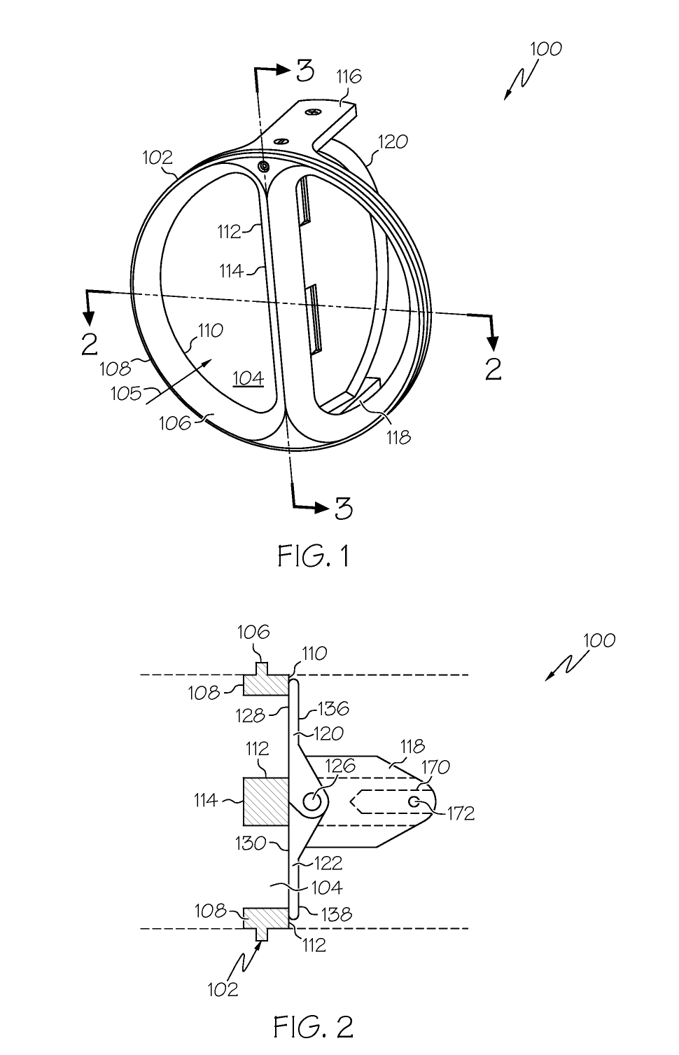

FIG. 1 is an isometric view of a check valve 100 in accordance with an exemplary embodiment. The check valve 100 includes a valve body 102 having an annular configuration defining a central flow passage 104. The valve body 102 can be coupled to or within a pipe or conduit (not shown) to enable fluid flow into the pipe or conduit through the flow passage 104 in direction 105. As will be discussed in further detail below, the check valve 100 is urged open by fluid flowing in the direction 105 while preventing fluid from flowing out of the check valve 100 in an opposite direction.

The valve body 102 has an annular flange 106 that defines the flow passage 104 and that includes an upstream surface 108 and a downstream surface 110. In one embodiment, the flow passage 104 is about 7 inches in diameter, although other sizes may be utilized depending on the specific application. The valve body 102 further includes a transverse post 112 that extends diametrically across the flow passage 104. Generally, the transverse post 112 has an upstream surface 114 that is coplanar with the upstream surface 108 of the annular flange 106. The valve body 102 also includes first and second flanges 116 and 118, respectively, that extend perpendicularly to the plane of the annular flange 106.

As best shown in FIG. 2, which is a cross-sectional view of the check valve 100 of FIG. 1 through line 2-2, two generally flat valve closure elements 120 and 122 (also referred to as “flappers” or “wafers”), each shaped generally like one-half of a circular disc, are pivotally mounted on a hinge assembly 126. The closure elements 120 and 122 are preferably identical, having flat and smooth upstream surfaces 128 and 130 and downstream surfaces 136 and 138. In alternate embodiments, the closure elements 120 and 122 can be replaced by a greater or fewer number of closure elements, and/or the closure elements can have different shapes other than the semicircular shape in the depicted embodiment.

As described in further detail below, the closure elements 120 and 122 resiliently biased into a closed position in which the upstream surfaces 128 and 130 of the closure elements 120 and 122 come to a fluid-tight rest against the downstream surface 110 of the annular flange 106, thus completely shutting off flow through the check valve 100. When the closure elements 120 and 122 are in their fully open position, as illustrated by the dashed image 170 of FIG. 2, the closure elements 120 and 122 rest against a stop 172 mounted in between the first and second flanges 116 and 118 generally parallel and downstream to the transverse post 112 and the hinge assembly 126.

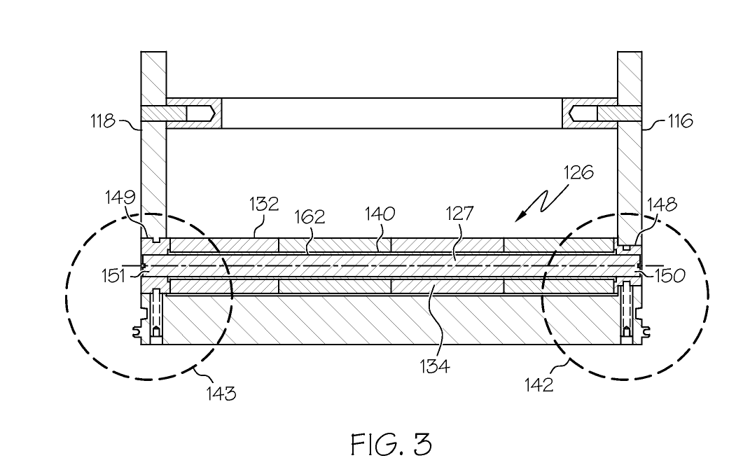

As best shown in FIG. 3, which is a cross-sectional view of the check valve 100 of FIG. 1 through line 3-3, the hinge assembly 126 includes a hinge shaft 127 having end portions 150 and 151 mounted and secured in holes 148 and 149 formed in the first and second flanges 116 and 118. The hinge shaft 127 is generally cylindrical and has a circumferential surface 162, although other configurations and cross-sectional shapes, such as square or hexagonal, can be provided. Generally, both holes 148 and 149 are through holes, although one or more of the holes 148 and 149 can be blind holes. The hinge shaft 127 extends across the flow passage 104, generally parallel to the transverse post 112. The mechanism for retaining the hinge shaft 127 in holes 148 and 149 of the flanges 116 and 118 is discussed in further detail below.

The hinge assembly 126 may include a helical spring 140 surrounding the hinge shaft 127. The helical spring 140 includes two ends 132 and 134 that bear against the downstream surfaces 136 and 138 (not shown in FIG. 3) of the closure elements 120 and 122 (not shown in FIG. 3), respectively, to bias them into their closed position (such as shown in FIG. 2). The force exerted by the helical spring 140 against the closure elements 120 and 122 is sufficient to hold them generally in the closed position, and to facilitate their automatic closure when fluid is not flowing through the valve, thereby preventing undesired reversed flow through the valve in the upstream direction. In an alternate embodiment, the helical spring 140 can be replaced by another resilient element, or omitted such that the valve is biased closed by gravity or air pressure.

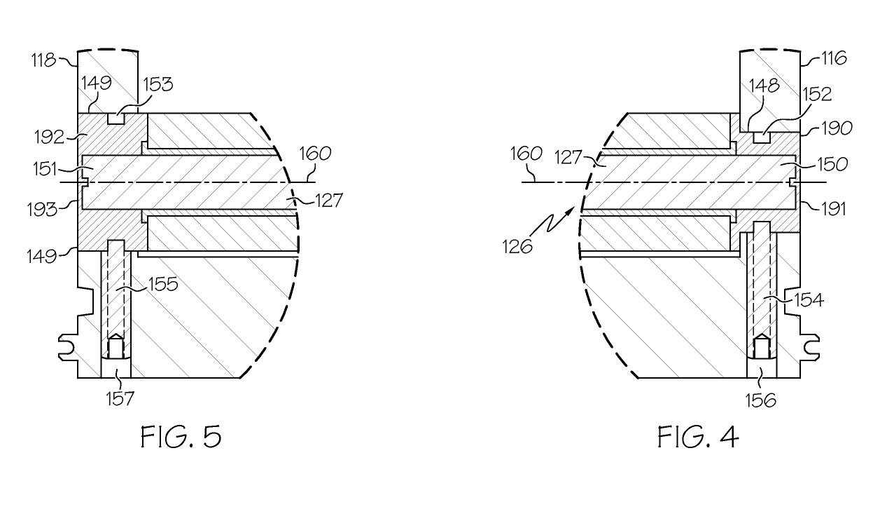

FIG. 4 illustrates circled portion 142 (FIG. 3) of the check valve 100 in greater detail. Particularly, FIG. 4 illustrates how the hinge shaft 127 is mounted and secured in the first flange 116. The hinge assembly 126 further includes a bushing 190 that couples the hinge shaft 127 to the first flange 116 in hole 150. The bushing 190 serves as a cylindrical lining for hole 150 and can be manufactured from the same or different material as the hinge shaft.

The bushing 190 is configured as a blind hole with a bottom wall 191 that prevents the hinge shaft 127 from migrating out of the bushing 190. The bushing 190 includes a groove 152 formed in its circumferential surface. The groove 152 is configured to receive a locking pin 154 inserted through a bore 156 in the valve body 102 that is aligned with the groove 152. The locking pin 154 is generally inserted at approximately 90° to a longitudinal axis 160 of the hinge shaft 127 and the bushing 190, although any angle between 45° and 135°, and preferably 80° and 100°, can be provided. The locking pin 154 prevents the bushing 190 (and thus, the hinge shaft 127) from moving along the longitudinal axis 160, thus preventing the hinge assembly 126 locking pin from migrating out of the hole 148 and out of the valve body 102. The locking pin 154 is securely retained in the bore 156 by threads formed on the locking pin 154 that cooperate with thread formed within the bore, i.e., a threaded screw attachment between the locking pin 154 and the bore 156.

FIG. 5 illustrates circled portion 143 (FIG. 3) of the check valve 100 in greater detail. Portion 143 is similar to portion 142 in that a bushing 192 couples the hinge shaft 127 to the second flange 118 in hole 149. The bushing 192 is configured as a blind hole with a bottom wall 193 that prevents the hinge shaft 127 from migrating out of the bushing 192. The bushing 192 includes a groove 153 formed in its circumferential surface. The groove 153 is configured to receive a second locking pin 155 inserted through a bore 157 in the valve body 102 that is aligned with the groove 153. The locking pin 155 is generally inserted at approximately 90° to a longitudinal axis 160 of the hinge shaft 127 and the bushing 191, although any angle between 45° and 135°, and preferably 80° and 100°, can be provided. The locking pin 155 prevents the bushing 191 (and thus, the hinge shaft 127) from moving along the longitudinal axis 160, thus preventing the hinge assembly 126 from migrating out of the hole 148 and out of the valve body 102. The locking pin 155 is securely retained in the bore 157 by threads formed on the locking pin 155 that cooperate with thread formed within the bore 157.

In an alternate embodiment, the grooves 152 and 153 on the bushings 190 and 192 replaced by a slot or hole. In another embodiment, locking pin 155 can be omitted and the hinge assembly 126 can be retained by the single locking pin 154. Moreover, in yet another alternate embodiment, one or more of the bushings 190 and 192 can be welded to the hinge shaft 127.

The locking pins 154 and 155 and the bushings 190 and 192 enable the hinge shaft 127 to be retained without a substantial change to the weight and/or space requirements of the check valve 100. Moreover, the locking pins 154 and 155 and the bushings 190 and 192 retain the hinge shaft 127 in high temperature and/or vibration environments. The check valve 100 can be manufactured from any suitable metallic or non-metallic material, including plastics and ceramics. In one embodiment, the valve body 102, the closure elements 120 and 122, bushings 190 and 192, and the hinge shaft 127 can be manufactured from aluminum, and the locking pins 154 and 155 can be manufactured from stainless steel. Generally, the check valve 100 is manufactured to withstand temperatures from about −40° F. to about 330° F. Although embodiments have been discussed in connection with check valves, the locking pins 154 and 155 and the bushings 190 and 192 can retain a hinge shaft 127 in other types of valves.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A check valve, comprising:
a valve body defining a flow passage therethrough;
a hinge shaft;
a bushing coupling the hinge shaft to the valve body;
a pin secured to the valve body and engaging the bushing; and
a closure element pivotally mounted on the hinge shaft for opening and closing the flow passage.

2. The check valve of claim 1, wherein the pin engages the bushing to prevent movement of the bushing and the hinge shaft in a longitudinal direction.

3. The check valve of claim 1, wherein the bushing has a circumferential surface, and wherein the bushing engages the pin at the circumferential surface.

4. The check valve of claim 1, wherein the valve body comprises a bore for housing the pin.

5. The check valve of claim 1, wherein the bushing comprises a cylindrical body with an open end and a closed end.

6. The check valve of claim 1, wherein hinge shaft has first and second end portions, and wherein the bushing couples the first end portion of the hinge shaft to the valve body.

7. The check valve of claim 1, wherein hinge shaft has first and second end portions, and wherein the bushing is a first bushing mounted on the first end portion for coupling the hinge shaft to the valve body.

8. The check valve of claim 7, further comprising a second bushing mounted on the second end portion and coupled to the valve body.

9. The check valve of claim 8, wherein the pin is a first pin received by the first bushing, and the check valve further comprises a second pin secured to the valve body and engaging the second bushing.

10. The check valve of claim 9, wherein the valve body has first and second holes for respectively receiving the first and second bushings.

11. The check valve of claim 1, wherein the bushing includes a groove for receiving the pin.

12. The check valve of claim 1, wherein the pin is oriented at approximately 90° to the hinge shaft.

13. A method of retaining a hinge shaft in a check valve, the method comprising the steps of:
mounting a bushing on the hinge shaft to couple the hinge shaft to a valve body of the check valve;
inserting a pin in a groove of the bushing; and
securing the pin to a valve body of the check valve to prevent movement of the bushing and the hinge shaft in a longitudinal direction.

14. The method of claim 13, wherein the inserting step includes inserting the pin at approximately 90° relative to the longitudinal direction.

15. The method of claim 13, wherein the inserting step includes inserting the pin in a bore in a body of the check valve that is aligned with the groove.

16. The method of claim 13, wherein the inserting step includes inserting the pin in the groove on a circumferential surface of the bushing.

17. The method of claim 13, wherein the bushing is a first bushing mounted on the first end of the hinge shaft and the pin is a first pin, and wherein the method further comprises:
mounting a second bushing on a second end of the hinge shaft;
inserting a second pin in a groove of the second bushing; and
securing the second pin to the valve body.

18. A check valve, comprising:
a valve body comprising a flow passage and a bore;
a hinge shaft;
a bushing having a circumferential surface and coupling the hinge shaft to the valve body;
a pin at least partially housed in the valve body and engaging the bushing at the circumferential surface to prevent movement of the bushing and the hinge shaft in a longitudinal direction; and
a closure element pivotally mounted on the hinge shaft for opening and closing the flow passage.

19. The check valve of claim 18, wherein the bushing comprises a cylindrical body with an open end and a closed end.

20. The check valve of claim 18, wherein the hinge shaft has first and second end portions, the bushing is a first bushing mounted on the first end portion, and the pin is a first pin, and
wherein the check valve further comprises:
a second bushing mounted on the second end portion; and
a second pin at least partially housed in the valve body and engaging the second bushing.
